(19) United States
(12) Patent Application Publication
(10) Pub. No.: US 2024/0061003 A1
(43) Pub. Date: Feb. 22, 2024

(54) PIPETTE TIPS, PIPETTE ASSEMBLIES, ASPIRATION AND DISPENSE SYSTEMS, AND METHODS OF PREVENTING PIPETTE TIP STICTION

(71) Applicant: Siemens Healthcare Diagnostics Inc., Tarrytown, NY (US)

(72) Inventor: Simin Yao, Boonton, NJ (US)

(73) Assignee: Siemens Healthcare Diagnostics Inc., Tarrytown, NY (US)

(21) Appl. No.: 17/754,525

(22) PCT Filed: Oct. 6, 2020
(86) PCT No.: PCT/US2020/054328

§ 371 Date: Apr. 5, 2022

Related U.S. Application Data
(60) Provisional application No. 62/927,889, filed on Oct. 30, 2019.

(51) Int. Cl. G01N 35/02; G01N 35/10; B01L 3/02

(52) U.S. Cl. CPC G01N 35/025; G01N 35/1079; B01L 3/0237; G01N 2035/103; B01L 2300/0858; B01L 2300/0672; B01L 2300/044

(57) ABSTRACT

A pipette tip configured to aspirate and dispense liquids. The pipette has a tip comprising an opening, wherein the pipette has one or more blades having a length extending at least partway from the tip, and at least some of the one or more blades include an acute-angled cutting edge along the length. In some embodiments, the pipette tip is part of a detachable pipette tip having a tip body with a first end configured to detachably couple to a pipette. Other detachable pipette tips, pipette tips, pipette assemblies, aspiration and dispense systems, testing apparatus, and methods of accessing a well through a well cover are disclosed.

### FIELD

The present disclosure relates to pipette tips, pipette assemblies, aspiration and dispense systems, and methods adapted to aspirate and dispense a liquid, such as a liquid reagent in an analyzer.

### BACKGROUND

In automated analytical testing (immunoassay instruments, clinical chemistry analyzers, in vitro testing apparatus, and the like—herein each is referred to as an analyzer or analyzers herein), various liquids may be aspirated at one location and dispensed to another. For example, in some embodiments, a reagent liquid may be aspirated from a reagent receptacle (otherwise referred to herein as a “well”) and transferred to a reaction vessel (e.g., a cuvette). In certain analyzers used to test for the presence of an analyte or another constituent in a biological fluid sample (otherwise referred to herein as a “specimen”), it may be desirable to utilize one or more pipette assemblies coupled to one or more aspiration/dispense apparatus comprising a pump to aspirate and then dispense a specimen, reagent, or other liquid. A robot may be coupled to the pipette assembly to cause coordinate thereof, and thus coordinate motion of the pipette.

In some embodiments, a fairly large number of reagents may be contained in individual wells of a reagent cartridge that are accessible by the pipette assembly, referred to herein as a “reagent pack.” The reagent pack may be supported on a carousel or like moveable member in some analyzers, for example. The pipette assembly can include a pipette and in some cases may include a detachable pipette tip that is coupled to the pipette. The detachable pipette tip may be a molded plastic pipette tip that is coupled to the pipette and then discarded after one or more aspiration/dispense sequences. For example, the detachable pipette tip can be separated from the pipette and dropped into a waste disposal container.

In some embodiments, the robot coupled to the pipette assembly can cause the pipette assembly to move from the location of the reagent pack to a location of a reaction vessel within the analyzer. So the robot may be able to move the pipette assembly in an X motion, Y motion, a sweeping (theta) motion, an r motion, or any combination thereof. Furthermore, the robot may include a Z-axis motor to be able to raise and lower the pipette assembly along a Z axis, thus enabling insertion and retraction of the pipette assembly and pipette vertically into and from the reagent pack, and/or reaction vessel.

In some embodiments, the reagent pack can contain one or more wells containing volumes of one or more process liquids (e.g., a reagent or other liquid) and can further have a sealed well cover (e.g., a foil cover) secured over a top of each well. When accessing the reagent pack with the pipette assembly, the pipette tip of the detachable pipette tip acts as a lance operating to pierce the well cover when the robot imparts a minus Z-axis motion (downward vertical motion).

Any malfunction of the pipette assembly can cause throughput or other process disruptions.

### SUMMARY

According to a first aspect, a pipette tip of a pipette assembly configured to aspirate and dispense a liquid is provided. The pipette tip includes a tip body having a first end configured to detachably couple to a pipette, and a tip located opposite from the first end, the tip comprising an opening, wherein the pipette tip further comprises one or more blades having a length extending at least partway from the tip to the first end, at least some of the one or more blades comprising an acute-angled cutting edge along at least a portion of the length

According to a second aspect, a pipette assembly configured to aspirate and dispense a liquid is provided. The pipette assembly includes a moveable body, and a pipette coupled to the moveable body, the pipette further comprising a pipette tip portion comprising a tip having an opening, wherein the pipette tip portion further comprises multiple blades each having a length extending at least partway from the tip, the multiple blades each comprising an acute-angled cutting edge along at least a portion of their length.

According to a third aspect, an aspiration and dispense system is provided. The aspiration and dispense system includes an aspiration and dispense assembly comprising a pump; a pipette assembly configured to aspirate and dispense a liquid, the pipette assembly comprising a pipette tip portion further comprising: a tip comprising an opening and further comprising one or more blades having a length extending at least partway from the tip, the one or more blades comprising an acute-angled cutting edge along the length; and a passageway connected between the pipette assembly and the pump.

According to a fourth aspect, a pipette configured to aspirate and dispense a liquid, is provided. The pipette includes a pipette body having a tip comprising an opening and an axial length, wherein the pipette body further comprises one or more blades extending from the tip along the axial length, the one or more blades comprising an acute-angled cutting edge along at least a portion of the axial length.

In another aspect, a method of accessing a well that is covered by a well cover with a pipette is provided. The method includes providing a pipette body portion having a tip comprising an opening and an axial length, wherein the pipette body portion further comprises multiple blades extending from the tip along the axial length, at least some of the multiple blades comprising an acute-angled cutting edge along the axial length; and cutting the well cover with at least some of the multiple blades comprising an acute-angled cutting edge.

Still other aspects, features, and advantages of the present disclosure may be readily apparent from the following description by illustrating a number of example embodiments and implementations. The present invention may also be capable of other and different embodiments, and its several details may be modified in various respects, all without departing from the scope thereof. Accordingly, the drawings and descriptions are to be regarded as illustrative in nature, and not as restrictive. The disclosure is to cover all modifications, equivalents, and alternatives falling within the scope of the claims.

### BRIEF DESCRIPTION OF THE DRAWINGS

The drawings, described below, are for illustrative purposes only and are not necessarily drawn to scale. The drawings are not intended to limit the scope of the disclosure in any way. Like numerals are used throughout to denote the same or like elements.

FIG. 1A illustrates a top view of a schematic diagram of portions of a testing apparatus including a pipette according to one or more embodiments.

FIG. 1B illustrates a cross-sectioned side view of a reagent pack used in a testing apparatus according to one or more embodiments.

FIG. 1C illustrates a partial cross-sectioned side view of part of a pipetting assembly that may be included in a testing apparatus according to one or more embodiments.

FIG. 1D illustrates a partially cross-sectioned side view of a portion of a pipette assembly including a detachable pipette tip having one or more acute-angled cutting edges thereon according to one or more embodiments.

FIG. 2A illustrates a side, elevation view of a pipetting assembly showing a detachable pipette tip being detached from a pipette according to one or more embodiments.

FIG. 2B illustrates a side, elevation view of a pipetting apparatus showing a detachable pipette tip being attached to a pipette according to one or more embodiments.

FIG. 3A illustrates a perspective view of a detachable pipette tip according to one or more embodiments.

FIG. 3B illustrates a side plan view of a detachable pipette tip according to one or more embodiments.

FIG. 3C illustrates a cross-sectioned side view of a detachable pipette tip taken along section line 3C-3C of FIG. 3B according to one or more embodiments.

FIG. 3D illustrates a bottom end view of a detachable pipette tip according to one or more embodiments.

FIG. 3E illustrates a cross-sectioned view of a detachable pipette tip taken along section line 3E-3E of FIG. 3B illustrating multiple blades comprising acute-angled cutting edges along a portion of their length according to one or more embodiments.

FIG. 4A illustrates a partial side view of a pipetting apparatus and a cross-sectioned side view of a reagent pack with a pipette tip extending into a well of the reagent pack, wherein the pipette tip is shown cutting (slicing) the well cover according to one or more embodiments.

FIG. 4B illustrates a cross-sectioned view of a detachable pipette tip sectioned above the well cover and showing four cuts formed by the cutting of the multiple blades comprising acute-angled cutting edges according to one or more embodiments.

FIGS. 5A and 5B illustrate partially cross-sectioned side views of a pipette assembly including a pipette with multiple blades having acute-angled cutting edges formed thereon according to one or more alternate embodiments.

FIG. 6A illustrates a perspective view of an alternate embodiment of a detachable pipette tip including three blades having acute-angled cutting edges formed thereon.

FIG. 6B illustrates a bottom end view of a detachable pipette tip having three blades including acute-angled cutting edges formed thereon.

FIGS. 7A and 7B illustrate partial perspective views of ends of an alternate embodiment of a detachable pipette tip including multiple blades having acute-angled cutting edges formed thereon.

FIG. 7C illustrates a bottom end view of an alternate embodiment of a pipette tip including multiple blades having acute-angled cutting edges formed thereon.

FIG. 7D illustrates a side plan view of an end of an alternate embodiment of a pipette tip including multiple blades having acute-angled cutting edges and a conical tip portion formed thereof.

FIG. 7E illustrates a side plan view of an alternate embodiment of a detachable pipette tip including multiple blades including acute-angled cutting edges and a conical tip portion.

FIG. 7F illustrates a cross-sectioned view of an alternate embodiment of a detachable pipette tip including multiple blades having acute-angled cutting edges taken along section line 7F-7F of FIG. 7E.

FIG. 8 illustrates a flowchart of a method of piercing a well cover with a pipette tip according to one or more embodiments.

### DETAILED DESCRIPTION

As described above, the reagent pack has one or more wells formed therein that contain one or more volumes of a process material, such as a process liquid (e.g., a liquid reagent, liquid buffer, liquid wash solution, specimen, or other process liquid) and the one or more wells have a well cover (e.g., a foil cover) sealing over a top thereof. When accessing a well of the reagent pack with the pipette, the pipette tip acts as a lance to pierce the well cover.

As was discovered by the inventors hereof, the detachable pipette tip can under certain conditions become lodged or stuck in the well cover of the reagent pack when retracting the pipette assembly therefrom. As such, the detachable pipette tip can inadvertently separate from the pipette and remain lodged in the well cover (e.g., the foil cover) of the reagent pack. Although this may only cause a minor disruption in cases where the analyzer operation is being overseen by an operator (by a person). In those instances, the operator can simply access and remove the detachable pipette tip from the reagent pack, with little resulting process down time.

However, in certain instances, such as at night, there may be hundreds, if not thousands, of tests running automatically, i.e., without the oversight of an operator, and just one detachable pipette tip getting lodged or stuck in the reagent pack can stop any further tests from being carried out on the analyzer that night. In this instance, a whole shift of testing could be lost, with accompanying loss in productivity and throughput. Accordingly, it is desired to minimize or eliminate such instances of detachable pipette tip lodging.

In other embodiments, the process of piercing the well cover can create internal pressure within the well and can create other problems as well. As the pipette is inserted deeper into the well and finally tears the well cover, air may leak around the pipette and rapidly escape, which in some instances can entrain liquid reagent or other liquid into the air stream. Thus, the inventors herein have further invented a mechanism for providing pressure relief functionality between the pipette and the well cover by introducing cuts in the well cover, enabling air to escape and minimizing or eliminating pressure buildup in the well. Further, in some instances conventional pipette tips can act as a punch to punch out a small film disc from the well cover during piercing, which then can fall into the well. This can cause problems (e.g., clogging) if the film disc is aspirated by the pipette.

In view of the foregoing problems, embodiments of the present disclosure provide apparatus, assemblies, and methods that are configured to provide reduce “stiction” between the outer surface of the pipette tip and the well cover and thus minimize or eliminate altogether instances of a detachable pipette tip lodging in the well cover. The apparatus, assemblies, and methods can also be configured to alleviate or minimize pressure buildup or rapid pressure loss in the well and/or eliminate the punching out of film discs.

Stiction as used herein means the static friction that needs to be overcome to enable relative motion of stationary objects in contact with one another. In conventional pipette operation, the conically-shaped pipette tip pierces the well cover, is inserted to a desired depth, and then an aspiration of the liquid (e.g., liquid reagent or other liquid) takes place. When the pipette tip pierces the well cover, there are generally three stages of the piercing process. In the first stage, the piercing imparts/pierces a small hole in the cover of the size of the terminal end of the pipette tip. In some cases, undesirably, a film disc can be punched out. In the second stage, the pipette tip, which has a smooth, slender conical outer shape, is further inserted into the well through the well cover, and the well cover further deforms but does not tear in any substantial way, so that a substantial normal force is built up on the outer surface of the pipette tip by the well cover acting thereon. Furthermore, pressure builds in the well, and a third stage where after a certain depth of insertion through the cover in the second stage, the stresses become so large that the cover tears and the stress is relieved. Once the cover tears, the third stage starts and thereafter further insertion of the pipette does not produce as large of stiction as in the second stage. Misting or spraying of the process liquid contained in the well (e.g., liquid reagent or other liquid) can occur in some instances as the well cover tears and the built-up well pressure is rapidly released therefrom.

Thus, it should be understood that in conventional systems employing a conventional conically-shaped pipette tip, up until a radial tear is produced in the well cover, there is substantial stiction between the well cover and the outer surface of the conical pipette tip that has pierced the well cover. In some instances, when accessing the liquid (e.g., liquid reagent), the terminal end of the pipette tip is only inserted to a point just below the surface of the liquid, which is just below the well cover, such as when the reagent pack is fresh, and for the first several aspirations of liquid, the pipette is operated within the second stage. As the pipette is stopped in its vertical plunge in the second stage to accomplish an aspiration, there then can be substantial stiction present. In some instances, the stiction is so substantial that upon attempting to retract the pipette tip from the reagent pack so that the reagent (or other liquid) can be dispensed to another vessel (e.g., to a reaction vessel), the pipette tip can separate from the pipette and the detachable pipette tip can remain rather securely lodged in the well cover. Further, using conventional conically-shaped pipette tips, a film disc can sometimes be punched out.

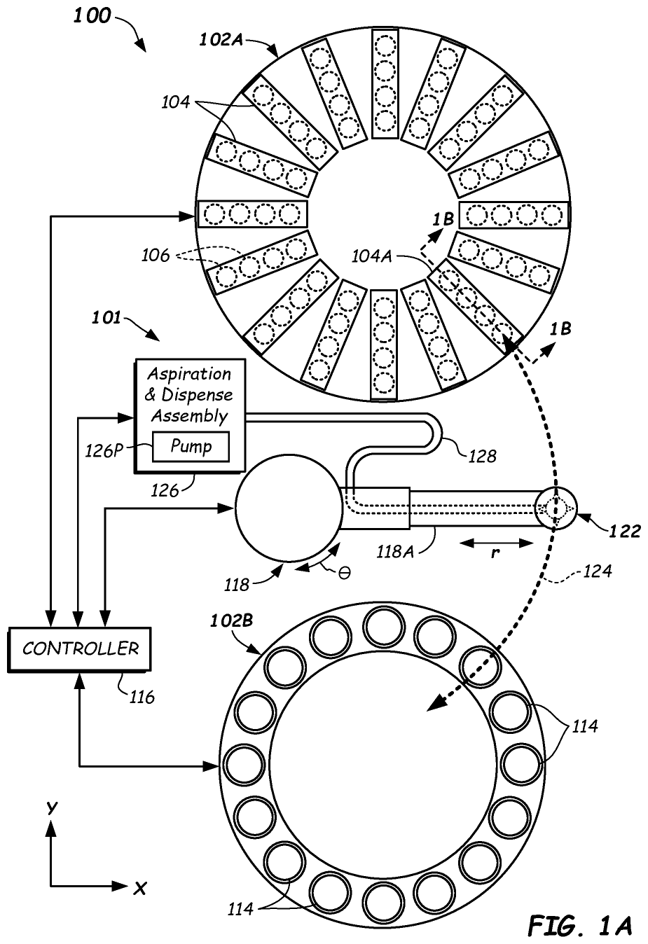

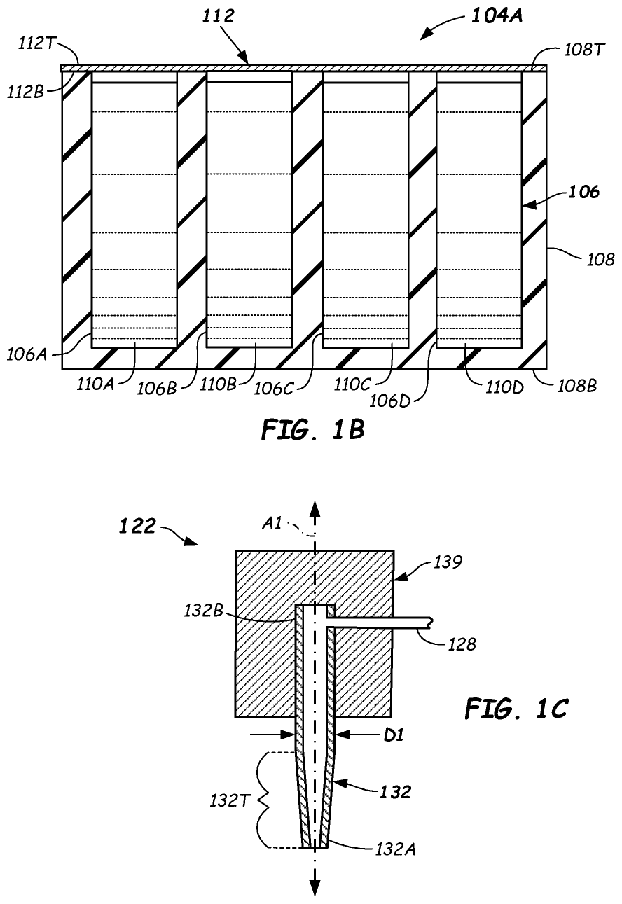

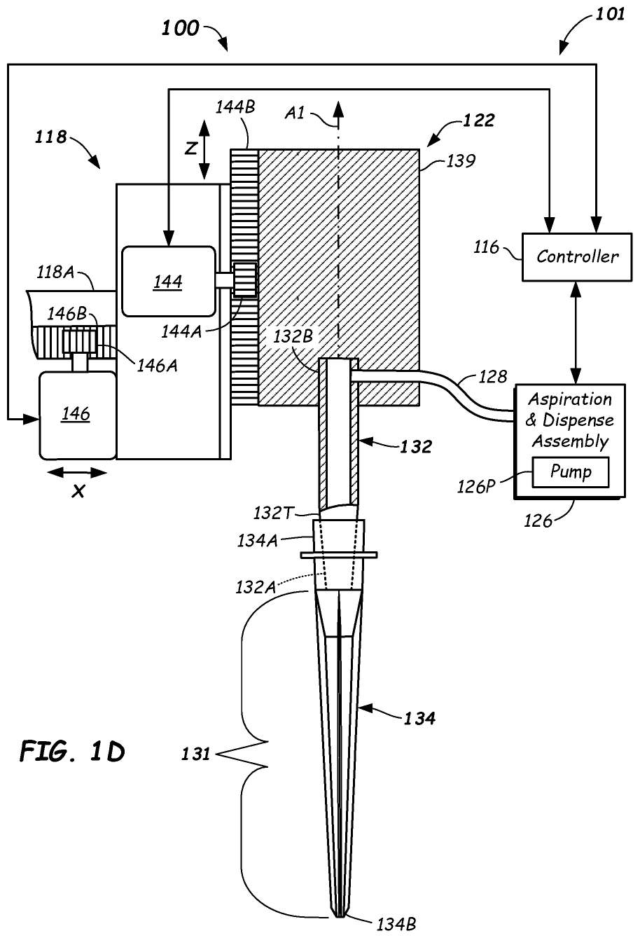

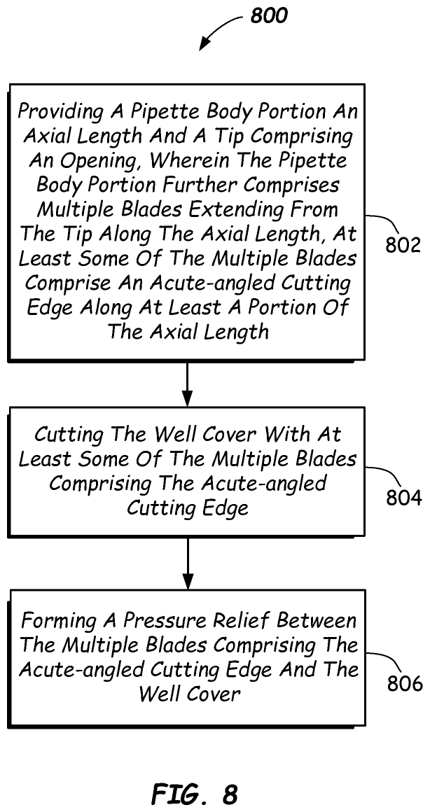

Embodiments described herein disclose pipette tips, detachable pipette tips, pipette assemblies, aspiration and dispense systems, testing apparatus, and methods of piercing a well cover wherein the problem of stiction is overcome or reduced, thus minimizing or eliminating instances where the detachable pipette tip becomes lodged in the well cover. In some embodiments, problems of liquid misting or spraying and/or the problem of punching out a film disc, which then falls into the well, can be overcome or reduced. These and other aspects and features of embodiments of the disclosure will be described with reference to FIGS. 1A-8 herein.

Reference is now made to FIG. 1A, which illustrates a top schematic view of portions of a testing apparatus 100. The testing apparatus 100 may be an analyzer and may include more components than are illustrated in FIG. 1A, such as heater(s), wash station(s), cuvette and pipette tip loader(s), reader(s) for determining concentration levels of an analyte or constituent, waste receptacle(s), motor(s), controller(s) and other conventional analyzer components not shown. The testing apparatus 100 may include a location for supporting one or more reagent packs 104. In some embodiments, a reagent carousel 102A can support a plurality of reagent packs 104. Each of the reagent packs 104 may include one or more wells 106 (shown dotted), which are reservoirs configured to contain liquid reagent, for example. Covers (not shown in FIG. 1A) may be sealed over the one or more, and preferably all, of the wells 106. Other embodiments of the testing apparatus 100 may include accessing wells with well covers that are located in liquid containing devices other than reagent packs that include a sealing well cover.

Additional reference is made to FIG. 1B, which illustrates a side cross-sectioned view of an example of a liquid containing vessel, such as a reagent pack 104A. The reagent pack 104A may be identical to the other reagent packs 104 in the reagent carousel 102A (FIG. 1A) or optionally, at least some of the reagent packs 104A may have a different configuration, such as including more or less numbers of wells 106. The reagent pack 104A may include a reagent pack body 108, formed from a plastic material, for example, and a plurality of wells 106 formed in the reagent pack body 108. The reagent pack body 108 may include a reagent pack top surface 108T and a reagent pack bottom surface 108B that may be located opposite the reagent pack top surface 108T. The wells 106 may include access openings in the reagent pack top surface 108T that extend to locations proximate a closed surface of the reagent pack bottom surface 108B. Thus, each well 106 in the reagent pack body 108 may include an open top and a closed bottom.

In the embodiment depicted in FIG. 1B, the reagent pack 104A incudes four wells, which are referred to individually as a first well 106A, a second well 106B, a third well 106C, and a fourth well 106D. Other embodiments of the reagent pack 104A may include more than or less than four wells. Further, some of the wells 106 may include liquid reagent and other liquids may be provided in other wells 106, such as a wash liquid, a rinse liquid, a neutralizing liquid, one or more buffer liquids, a specimen, or any combination thereof.

In the embodiment depicted in FIG. 1B, the first well 106A contains a first reagent 110A, the second well 106B contains a second reagent 110B, the third well 106C contains a third reagent 110C, and the fourth well 106D contains a fourth reagent 110D. The various reagents 110A-110D may be the same or some or all may be different.

The reagent pack 104A may include a well cover 112 having a cover top surface 112T and a cover bottom surface 112B. The well cover 112 may be affixed to the reagent pack top surface 108T and may hermetically seal the various wells 106. For example, the cover bottom surface 112B may be affixed, such as adhered by a suitable adhesive, to the reagent pack top surface 108T in a manner that seals around the openings of the wells 106. In the embodiment depicted in FIG. 1B, the reagent pack 104A includes a well cover 112 that may be a single piece cover and that seals all the wells 106. In other embodiments, the reagent pack 104A may include individual covers that individually seal the wells 106.

The well cover 112 may be made of a material capable of being pierced by a pipette tip, such as thin layer including a metal foil. The foil may be pierced by a pipette tip 131, which may be part of a detachable pipette tip (e.g., detachable pipette tip 134—FIG. 1D) as described herein. The material may also prevent leakage of the reagents or other liquids contained in the wells 106. The material may also prevent contaminants from entering the wells 106 and vapors from entering and/or exiting the wells 106. In some embodiments, the well cover 112 can include a lamination of at least one layer of plastic and one layer of a metal, such as aluminum or an ally of aluminum. In some embodiments, the well cover 112 includes a metal layer and a plastic layer, or even a metal layer sandwiched by plastic layers.

Referring again to FIG. 1A, the testing apparatus 100 may include a sample carousel 102B that supports and/or receives a plurality of reaction vessels 114 therein. For example, the reaction vessels 114 may be received in receptacles of the sample carousel 102B. The reaction vessels 114 may contain at least liquid specimens acquired from patients. In some embodiments, the reaction vessels can be cuvettes. In some embodiments, the sample carousel 102B may be an incubation ring or other type of carousel that prepares specimens for testing, such as for determining a concentration of an analyte or other constituent in the specimen. Both the reagent carousel 102A and the sample carousel 102B may include electromechanical devices (e.g., a motor—not shown) and a transmission (not shown) that rotate the reagent carousel 102A and the sample carousel 102B. Both the reagent carousel 102A and the sample carousel 102B may be electrically coupled to a controller 116 that generates signals to operate the electromagnetic devices and other system components, such as cuvette ring heaters, wash stations, concentration reader devices, and the like.

The testing apparatus 100 may include a robot 118 that is configured to transport a pipette assembly 122 between the wells 106 in the reagent carousel 102A and the reaction vessels 114 in the sample carousel 102B. The robot 118 may include any suitable configuration, and may include a robot arm 118A to which the pipette assembly 122 is attached. In the embodiment depicted in FIG. 1A, the robot 118 is configured to move the arm 118A, and thus the pipette assembly 122, along an arc 124 between the reagent carousel 102A and the sample carousel 102B. For example, the robot 118 may be a theta robot configured to move the robot arm 118A in the +/−theta (Θ) direction, i.e. rotation. However, the robot 118 may be optionally configured to move the pipette assembly 122 in other directions than theta, such as r (extension and retraction along the arm 118A) thus producing motion in the X, Y plane. The robot 118 may further include the ability to move the pipette assembly 122 in the Z direction (into and out of the paper in FIG. 1A). Thus, the robot 118 can move the pipette assembly 122 in combinations of the X, Y, and Z directions. The robot 118 may be electrically coupled to the controller 116, which may generate signals to operate the robot 118.

The testing apparatus 100 may further include an aspiration and dispense assembly 126 that may be coupled to the pipette assembly 122 by a conduit 128, such as a flexible tube. The aspiration and dispense assembly 126 may control amounts of liquids aspirated and/or dispensed by the pipette assembly 122. The aspiration and dispense assembly 126 may be electrically coupled to the controller 116, which controls one or more pumps thereof responsive to one or more sensors (not shown) and the like to perform the aspiration and/or dispensing. The aspiration and dispense assembly 126 is conventional and thus not detailed further herein.

Additional reference is made to FIG. 1C, which illustrates a partial cross-sectioned view of a portion of an example pipette assembly 122. A pipette 132 may be attached to or be included within the pipette assembly 122. The pipette assembly 122 may be configured to dispense and/or aspirate one or more liquids into or out of the wells 106 (FIG. 1A) and/or the reaction vessels 114 (FIG. 1A). The pipette 132 can include a pipette terminal end 132A and a pipette upper end 132B. The pipette 132 also has an outer surface. The pipette terminal end 132A may include a pipette tapered portion 132T. The pipette tapered portion 132T may transition from a pipette widest transverse dimension D1 measured across the outer surface to a smaller transverse dimension at the terminal end 132A. Pipette tapered portion 132T can comprise a conical surface in some embodiments that is configured to couple to a detachable pipette tip 134 described herein.

As shown schematically in FIG. 1D, a pipette tip 131 can be part of the detachable pipette tip 134 that may be detachably coupled (coupled to and detachable—capable of being detached) from the pipette terminal end 132A of the pipette 132. The detachable pipette tip 134 may include a pipette tip first end 134A that may include a portion that couples to the tapered portion 132T, such as a like tapered portion. However, any suitable coupling configuration for detachably coupling and sealing the detachable pipette tip 134 to the pipette 132 may be used, such as a snap fit, or other type of coupler.

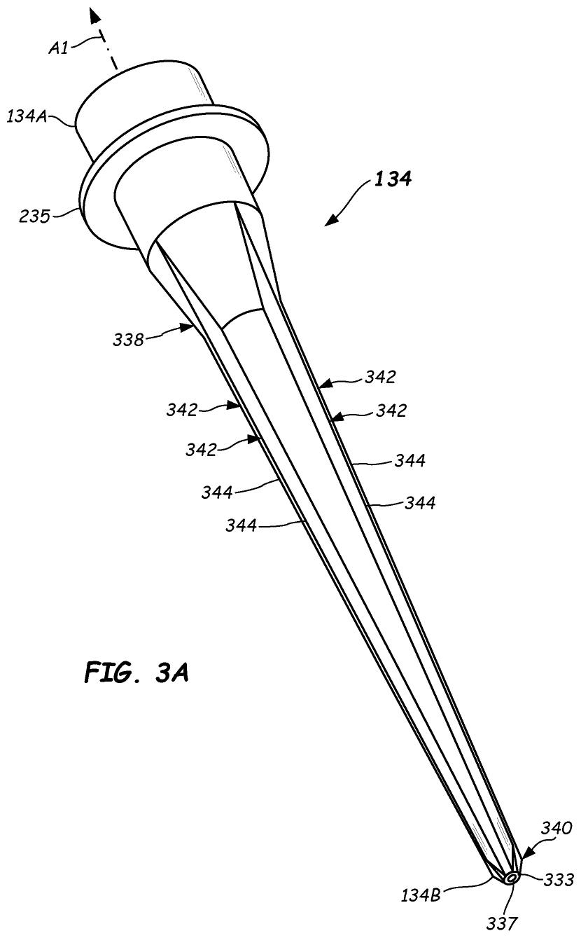

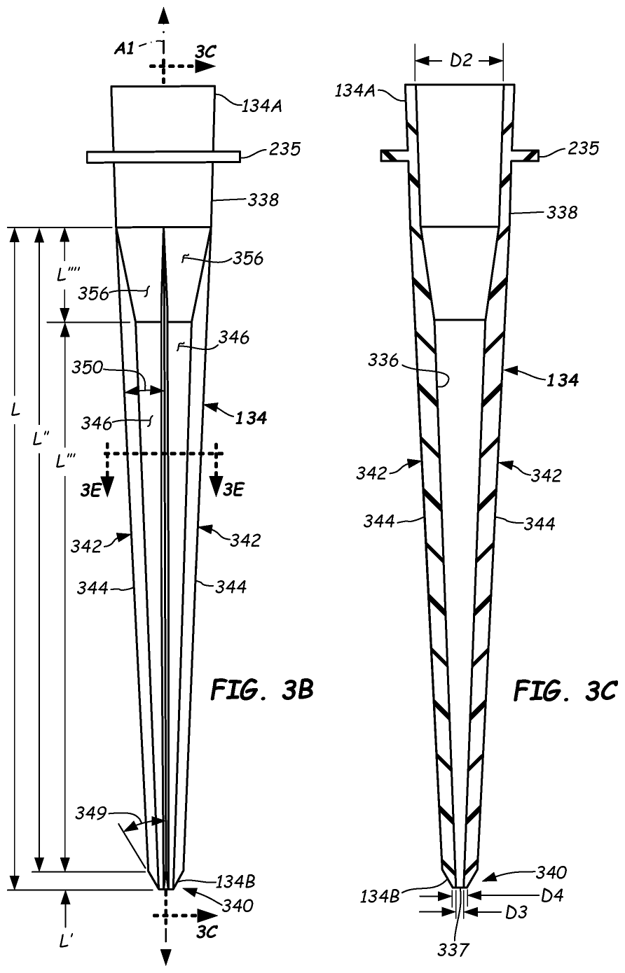

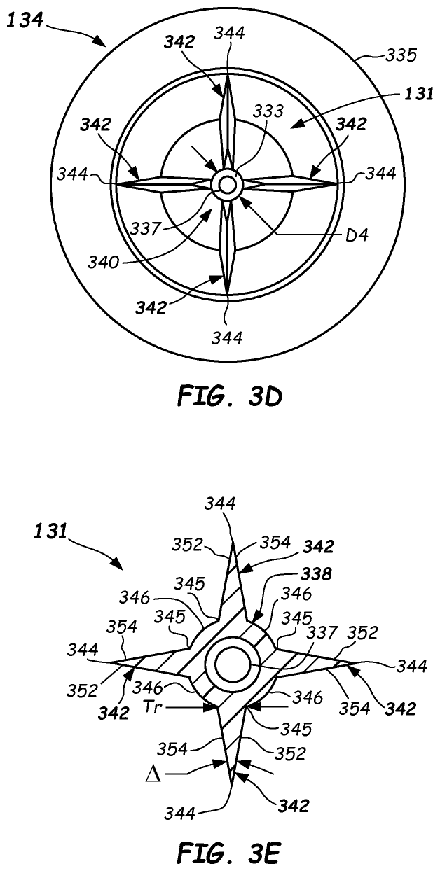

The detachable pipette tip 134 may also include a pipette tip second end 134B located opposite the pipette tip first end 134A. The pipette tip second end 134B may have an opening 337 (see FIG. 3C) configured to aspirate and dispense the liquid there through. The opening 337 may include an opening dimension D3 of between 0.5 mm and 2.0 mm, for example. The pipette tip second end 134B may further include a tip 340 (FIG. 3A-3B) that is configured to pierce the well cover 112 (FIG. 1B) of the reagent pack 104A (FIG. 1B). As will be apparent, the tip 340 is designed so as not to punch out a portion of the well cover 112 when piercing. In particular, the end of the tip 340 includes an annular (donut-shaped) surface 339 that lies in a plane that is substantially perpendicular to the axial axis A1. An outer diameter D4 of the annular surface 333 can be between 1.5 mm to 4.0 mm. To prevent punch out of a film disc, the width between the opening and the other dimension of the annular surface 333 should be greater 0.5 mm.

Optionally, the detachable pipette tip 134 can be used to pierce a cover of other types of vessels and/or wells present in the testing apparatus 100 or in other like testing apparatus, such as specimen containers, or other combination packs containing combinations of reagent wells and reaction vessel wells being covered with one common or more than one well cover.

Now referring to FIGS. 3A-3E, the detachable pipette tip 134 may include an internal passageway 336 that extends between the opening 337 in the pipette tip second end 134B and the pipette tip first end 134A, thus proving a passageway that is fluidly connecting to the conduit 128. The internal passageway 336 may vary in diameter between a first inner transverse dimension D2 at the pipette tip first end 134A and the second inner transverse dimension D3 at the pipette tip second end 134B and is configured to aspirate a liquid therein and dispense a liquid therefrom. The dimension D1 (FIG. 1C) may be from 5 mm to 15 mm, for example. The dimension D2 may be 5 mm to 15 mm, for example. Other dimensions may be used.

In more detail, the detachable pipette tip 134 comprises a tip body 338, which may be a molded plastic such as polypropylene or other suitable inert moldable materials, having the pipette tip first end 134A configured to detachably couple to a pipette 132, and the tip 340 located at the pipette tip second end 134B opposite from the pipette tip first end 132A. Tip 340 includes the opening 337 therein. The detachable pipette tip 134 further comprises one or more blades 342 thereon each having a length L extending at least partway from the tip 340 to the pipette tip first end 132A. In the depicted embodiment, the one or more blades 342 may extend more than 50% of the way from the tip 340 to the tip first end 134A, and more than 75% of the way from the tip 340 to the tip first end 134A, as shown. At least some of the one or more blades 342 have an acute-angled cutting edge 344 along at least a portion of the length L of the blades 342. As shown all of the blades 342 include an acute-angled cutting edge 344.

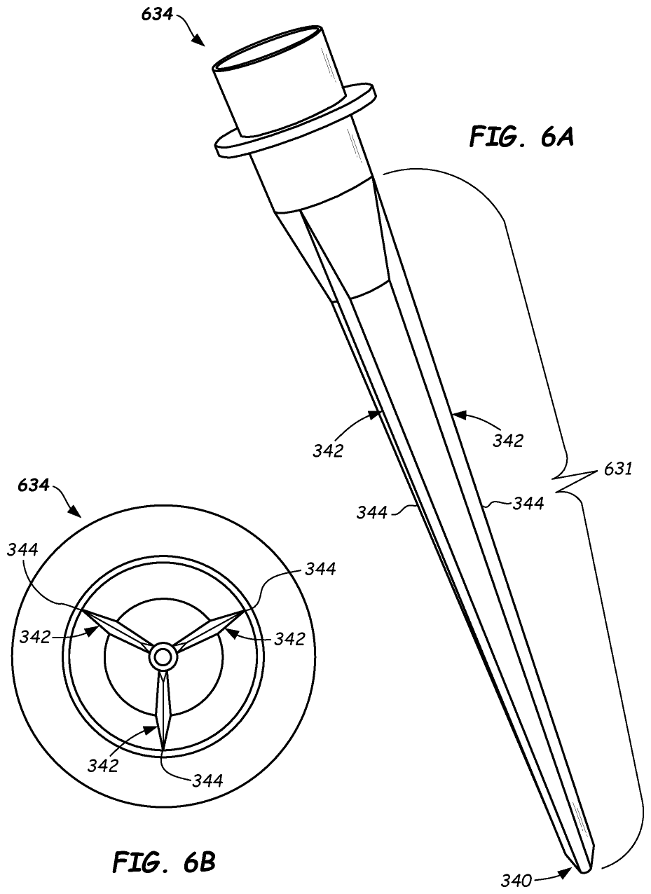

As best shown in FIGS. 3D-3E, the pipette tip 134 can include one or more blades 342. As shown multiple blades such as two or more blades (e.g., two opposing blades), three or more blades (See embodiment of FIGS. 6A-6B shown) or four or more blades (with four blades 342 being shown). The one or more blades 342, and in the embodiment shown all of the blades 342, can further comprise a cross-section at some locations along the length L that have a blade terminus comprising the acute-angled cutting edge 344. In some embodiments, the blades 342 can include a blade cross-sectional profile including, as shown in FIG. 3E, a blade root 345 where the blade 342 intersects with conical segments 346 of the pipette body 338.

As will be apparent from the following, this blade configuration can provide a pressure relief (a cut) in the well cover 112 as the blade 342 cuts through the well cover 112. In the embodiment shown, each of the multiple blades 342 can include the acute-angled cutting edge 344 along at least a portion of the length L. Thus, in one aspect, a pipette tip 131 comprising multiple blades 342 extending at least partway from the tip 340 is provided.

Furthermore, the one or more blades 342 can comprise, in plan view (shown in FIG. 3B), a first tapered profile along length L′ of the tip 340 and a second tapered profile along length L″ of the body 338 wherein the second tapered profile is less steep than the first tapered profile as measured relative to an axial axis A1. In particular, the first tapered profile of the pipette tip 131, as shown in FIG. 3B, can include a first taper angle 349 of from 22.5 degrees to 60 degrees, or even 30 degrees to 50 degrees, as measured relative to the axial axis A1 (axial centerline) of the pipette tip 131. Second tapered profile can include a second taper angle 350 of from 0.5 degrees to 4.0 degrees, measured relative to the axial axis A1 of the pipette tip 131.

In the depicted embodiment, the acute angled cutting edge 344 can extend along the length L″. The acute angled cutting edge 344 could extend along the length L′, as well. In some embodiments, the length L′ can include triangular-shaped planar surfaces extending from the flat annular tip end, as best shown in FIG. 3A. The flat annular tip end 333 may be formed in a plane perpendicular to the axial axis A1. Acute-angled cutting edge 344 can have a cutting angle Δ, as shown in FIG. 3E-3E, of from 25 degrees to 45 degrees, or even a cutting angle Δ of from 30 degrees to 40 degrees. This cutting angle Δ provides a knife-like edge that can readily cut the well cover 112 as the pipette tip 131 is driven in the −Z direction. In each of the embodiments shown, the acute-angled cutting edge 344 is formed by a first planar surface 352 intersecting with a second planar surface 354 to form the cutting angle Δ on at least some of the one or more blades, and, in the depicted embodiment, on all of the blades 342.

Again referring to FIG. 3B, the pipette body 338 comprises a first body portion extending along L′″ including first conical taper segments 346 and a second body portion extending along length L″″ including second conical taper segments 356, the blades 342 extending outwardly between the first conical taper segments 346 and the second conical taper segments 356 to the acute-angled cutting edge 344. In the depicted embodiment, the second conical taper segments 356 comprise a steeper cone angle than the first conical taper segments, as measured relative to the axial axis A1.

Again referring to FIG. 1C, the pipette assembly 122 may include a body 139 that receives or is coupled to at least a portion of the pipette 132. The body 139 may be a rigid structure (e.g., metal or other rigid material) that supports the pipette 132. The conduit 128 may couple the aspiration/dispense assembly 126 to the pipette 132 and may have enough flexibility to accommodate coordinate motion of the body 139 and attached pipette tip 131.

As shown in FIG. 1D, the robot 118 may include a Z-motor 144 that is configured to rotate a Z-pinion 144A relative to a Z-rack 144B coupled to the body 139. As the Z-motor 144 rotates, the pipette assembly 122, including the pipette 132 and pipette tip 134, moves in the Z-direction, which may be referred to herein as moving vertically up and down. The robot 118 may also include an r-motor 146 that is configured to rotate an r-pinion 146A relative to an r-rack 146B coupled to the arm 118A. As the r-motor 146 rotates, the pipette assembly 122 including the pipette tip 131 moves in the r-direction, which may be referred to herein as moving left and right. Other suitable mechanisms may be used to move the pipette assembly 122 in the Z-direction and the r-direction. In some embodiments, other suitable mechanisms may be used to move the pipette assembly 122 in an x-direction, Y-direction, and the Z-direction such as a gantry robot. Thus, the robot 118 may be designed to cause X motion, Y motion, Z motion, r motion, theta motion, or any combination thereof.

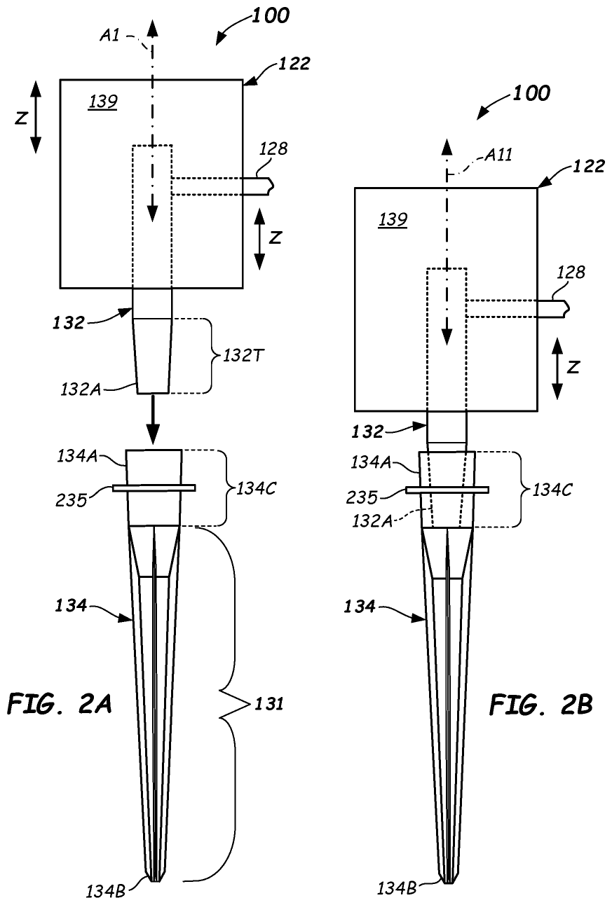

Additional reference is now made to FIGS. 2A and 2B, which illustrate elevational side views of the pipette assembly 122 showing the process of attaching the detachable pipette tip 134 to the pipette 132. FIG. 2A illustrates a side elevation view of the pipette assembly 122 with the detachable pipette tip 134 detached from the pipette 132. FIG. 2B illustrates a side elevation view of the pipette assembly 122 with the detachable pipette tip 134 successfully attached to the pipette 132, such as by a Z directional move of the robot 118.

The detachable pipette tip 134 depicted in FIGS. 2A-2B may include an extension 235, such as a flange or other suitable structure, that may facilitate insertion of the detachable pipette tip 134 onto the pipette 132 and/or removal of the detachable pipette tip 134 from the pipette 132. For example, the detachable pipette tip 134 may be moved to or reside at a location where a stationary structure (e.g., a ramp—not shown) may engage the extension 235 (e.g., flange) during removal and/or insertion of the detachable pipette tip 134 relative to the pipette 132. The stationary structure may hold the pipette tip 134 as the pipette terminal end 132A moves into or out of the pipette tip 134.

In more detail, the pipette assembly 122 and the pipette 132 may be moved by robot 118 to a location where the pipette terminal end 132A is located above the pipette tip first end 134A. The pipette assembly 122 may then be lowered in the Z-direction so that the pipette terminal end 132A is inserted into the pipette tip first end 134A as shown in FIG. 2B. Friction may secure the pipette tip 134 to the pipette 132. The pipette assembly 122 may then be moved by robot 118 to the location of a well 106 (FIG. 1A) or other locations to aspirate and/or dispense liquids.

Thus, in one embodiment, an aspiration and dispense system 101 is provided. The aspiration and dispense system 101 comprises the aspiration and dispense assembly 126 comprising a pump 126P, the pipette assembly 122 configured to aspirate and dispense a liquid (such as a liquid reagent, a buffer such as a lysis or elution buffer, a wash liquid, other process liquid, a specimen, and the like), wherein the pipette assembly 122 comprises the pipette tip 131, which may be embodied as part of a detachable pipette tip 134. The pipette tip 131 further includes the tip 340 comprising the opening 337, wherein the pipette tip 131 further comprises one or more blades 342 having a length L extending at least partway from the tip 340, the one or more blades 342 comprising an acute-angled cutting edge 344 along at least a portion of the length L, and a passageway 128 (e.g., tube) connected between the pipette assembly 122 and the pump 126P. The controller 116 may control the aspiration and dispense process by controlling the action of the pump 126P at the desired times. The aspiration and dispense assembly 126 may further include one or more sensors (not shown) adapted to sense the liquid surface, liquid level, and/or position in at least the Z-direction to facilitate and/or confirm the aspiration and dispense.

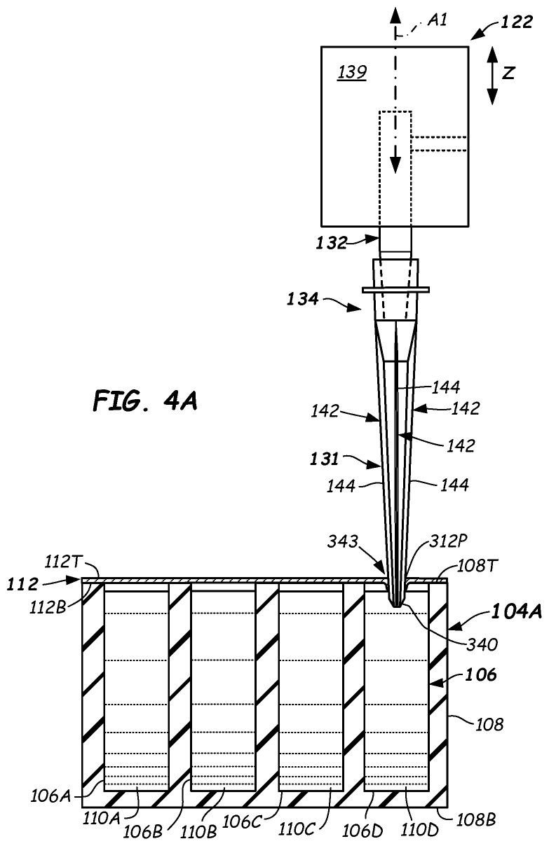

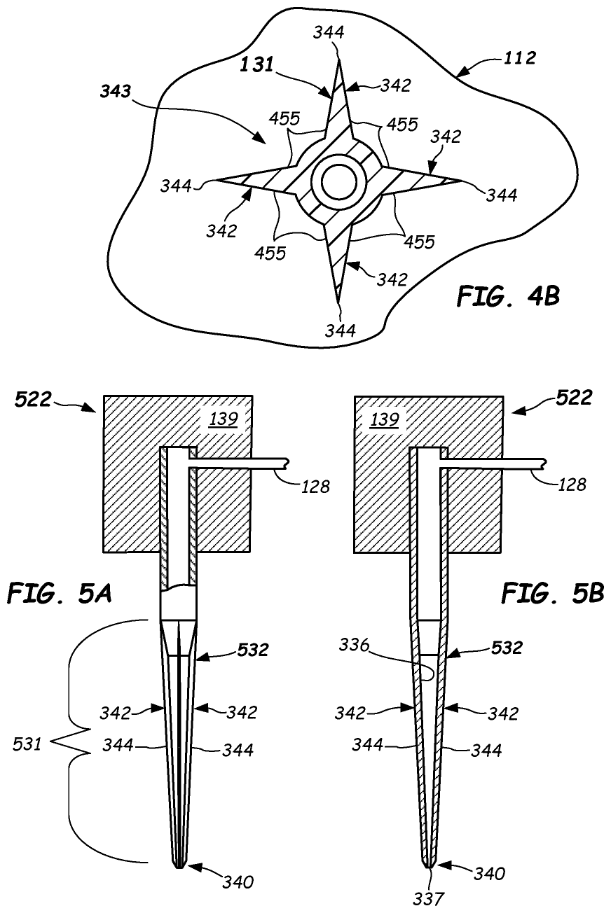

Additional reference is made to FIGS. 4A-4B, which illustrates the pipette tip 131 embodied in a detachable pipette tip 134 piercing the well cover 112 over the fourth well 106D of the reagent pack 104A. The pipette assembly 122 has been moved downward in the Z-direction toward the reagent pack 104A. As the pipette assembly 122 continues to move downward in the Z-direction, the tip 340 pierces the well cover 112 at a pierced location 312P thus creating a cover opening 343 in the well cover 112A. As the pipette assembly 122 continues to move downward in the Z-direction, the acute-angled cutting edge(s) 344 of the one or more blades 342 cut the well cover 112 to relive stress caused by piercing by the tip 340.

In the depicted embodiment, the one or more blades 342 can include a cross-sectional configuration as shown in FIG. 3E extending from the tip 340 along some or all of the length L, albeit the size is enlarged when progressing upwardly from the tip 340. This configuration includes planar surfaces 352, 354 extending fully from the acute angled cutting edge 344 to the blade root 345. The one or more blades 342 cut the well cover 112 with little resistance. Eventually, the pipette tip 131 is stopped in the Z-direction and the aspiration and dispense system 101 may aspirate the fourth reagent 110D from the fourth well 106D.

Moreover, the cut flaps of the well cover 112 offer little resistance to upward Z motion and thus the pipette stiction is effectively reduced. As such, incidences of lodging of the detachable pipette tip 134 in the well cover 112 are reduced or eliminated altogether. In conventional systems, stiction and the downward curvature of the well cover 112, individually or in combination, may cause a retention force that exceeds the coupling force between the pipette 132 and the conventional detachable pipette tip when the pipette 132 is moved in the upward Z-direction to retract the conventional pipette tip from the well.

FIG. 4B illustrates that the one or more blades 342 produce one or more cuts 455 between the well cover 112 and the one or more blades 342 as the cross section cuts through the well cover 112. The cuts in the well cover from the blades 342 helps reduce or eliminate the stiction there between. Further, these produced cuts 455 provide pressure relief that allows gas to escape from inside the well 106 so that pressure does not increase in the well as the pipette tip 131 is driven deeper into the well 106.

Thus, it should now be apparent that embodiments of the disclosure include a pipette assembly 122 that is configured to aspirate and dispense a liquid. The pipette assembly 122 further includes a pipette tip portion comprising a tip 340 having the opening 337, and further comprising one or more blades 342 (e.g., multiple blades, such as 2, 3 or 4 or more) having a length L extending at least partway from the tip 340, the one or more blades 342 comprising an acute-angled cutting edge 344 along at least a portion of the length L.

FIGS. 5A and 5B illustrate an alternative embodiment of the pipette assembly 522 with the robot 118 not shown for illustration purposes. In this embodiment, the pipette 532 includes the pipette tip 531 with the one or more blades 342 with the acute-angled cutting edges 344 formed therein. The configuration of the blades 342 can be the same as described above, except that the pipette 532 includes the pipette tip 531 and the blades 342 formed integrally thereon. In this embodiment, the pipette 532 may be made of metal or plastic, and may be provided as a one-piece structure. In a testing apparatus that includes a washable pipette, wherein the pipette may be washed at a wash station or location (not shown) after an aspiration and dispense sequence is completed, the configuration of the pipette 532 including blades 342 with the acute-angled cutting edge 344 can more easily pierce the well cover of a reagent-containing or other liquid-containing well (e.g., well 106).

Thus, as shown in FIGS. 5A and 5B, a pipette 532 configured to aspirate and dispense a liquid (e.g., reagent liquid, buffer liquid, wash liquid, other process liquid, or specimen, etc.) is shown. The pipette 532 includes a pipette body portion (pipette tip 531) having a tip 340 comprising the opening 337 therein and an axial length, wherein the pipette body portion further comprises one or more blades 342 extending from the tip 340 along the axial length, the one or more blades 342 comprising the acute-angled cutting edge 344 along at least a portion of the axial length. The configuration of the blades 342 can be as described in any of the embodiments herein, except that the pipette 532 has the pipette tip 531 integrally formed thereon, i.e., the pipette tip portion 531 is not detachable.

FIGS. 6A and 6B illustrate an alternate embodiment of the pipette tip 631 embodied as part of a detachable pipette tip 634. This configuration is substantially identical to the embodiment disclosed and described in FIGS. 3A-3E, except that it only includes three blades 342. The three blades 342 can be equally spaced at 120 degree increments, for example, wherein the four-bladed embodiments, the blades 342 are spaced at 90 degree increments. The configuration of the individual blades 342 can be as described in any of the embodiments disclosed herein and each of the blades 342 can include an acute-angled cutting edge 344 formed along at least a portion of the length of the blade 342. Optionally, the configuration of the pipette tip 131 could be directly embodied as a part of the pipette, like shown in FIGS. 5A-5B, and, thus would not be detachable.

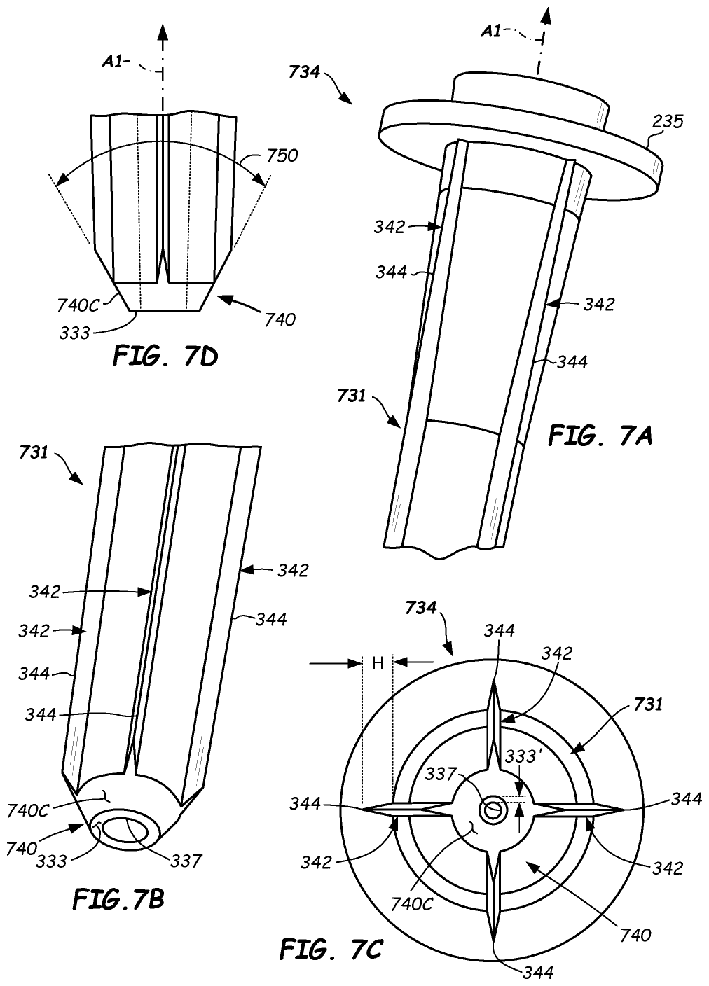

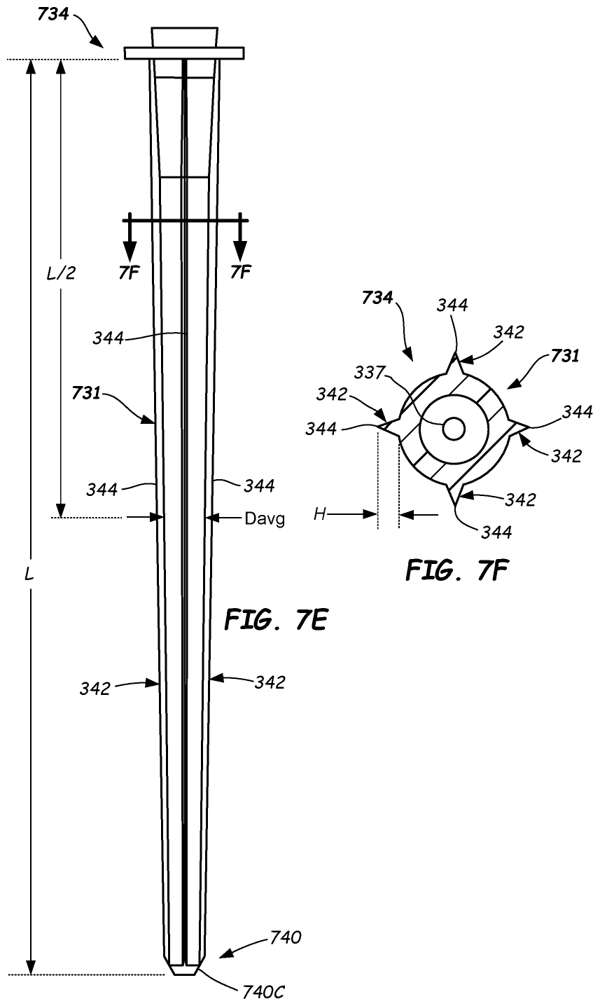

FIGS. 7A through 7F illustrate various views of an alternate embodiment of a pipette tip 731 that can be embodied as part of a detachable pipette tip 734, for example. This configuration is substantially similar to the embodiment disclosed and described in FIGS. 3A-3E, except that the pipette tip 731 includes a slightly different configuration of the tip 340 and a slightly different slenderness ratio (L/Davg) as will be described below. Further, the blades 342 extend from the tip 340 all the way to the flange 235. The blades 342 can be equally spaced at 90 degree increments about the periphery as shown in FIG. 7C, for example. The configuration of the individual blades 342 can be as described in any of the embodiments disclosed herein and each of the blades 342 can include an acute-angled cutting edge 344 formed along at least a portion of the length of the blade 342. As shown, the acute-angled cutting edge 344 is formed as an acute cutting angle Δ of from 25 degrees to 45 degrees, or even a cutting angle Δ of from 30 degrees to 40 degrees. Optionally, the configuration of the pipette tip 731 could be integrally formed as a part of the pipette, like shown in FIGS. 5A-5B, and, thus would not be a detachable pipette tip. In this instance, the pipette tip may be metal or an engineering plastic.

Referring to FIGS. 7B, 7C, and 7E-7F, the configuration of the pipette tip 731 will be further explained. In particular, the pipette tip 731 as shown can comprise a planar annulus 333 surrounding the opening 337, the planar annulus 333 can comprise an annular radial thickness 333′ greater than 0.5 mm and less than 1.0 mm, as measured across the flat as shown in FIG. 7C. The size of the planar annulus 333 should be limited within a range so that the penetration force to pierce the well cover 112 is minimized, but not so small that the tip 340 acts like a punch to punch out a circle from of the well cover 112, which may fall into the well 106 and possibly be later aspirated. The planar annulus 333 surrounding the opening 337 can, as shown, lie in a plane perpendicular to an axial axis A1 of the pipette tip 731. The tip 740 as shown can further comprise a conical portion 740C surrounding the planar annulus 333. The conical portion 740C can include a cone angle 750 of from 45 degrees to 120 degrees, or even from 60 degrees to 100 degrees, as an included angle measured between the opposed sides of the conical portion 740C in a side plan view. Having the cone angle 750 be too large results in too much penetration force, whereas too small of a cone angle 750 does not allow for a rapid transition to where the well cover 112 starts to be cut by the one or more blades 342. The configuration and dimensions of the tip 340 shown in FIGS. 7A-7F, and, in particular, the configuration of the planar annulus 333 and/or conical portion 740C, may be implemented in other embodiments of the pipette tip described herein.

As shown, the pipette tip 731 includes a slenderness ratio (SR) of from 10 to 30, or even from 15 to 25. SR is defined herein as L/Davg, where L is the length of the tip 731 from the tip 740 to the end of the one or more blades 734. Davg is the diameter across the body of the pipette tip 731 at the blade root (not across the blades) measured at L/2. The length L can range from 30 mm to 150 mm, or even from 50 mm to 100 mm. The height H of the blades in this embodiment can be between 0.5 mm and 2.0 mm, for example.

According to a method aspect, a method 800 of accessing a well (e.g., well 106 or other liquid-containing well (reservoir)) covered by a well cover 112 (e.g., a foil cover) with a pipette assembly (e.g., pipette assembly 122). The method 800 includes, at 802, providing a pipette body portion having an axial length and a tip (e.g., tip 340) comprising an opening (e.g., opening 337), wherein the pipette body portion further comprises multiple blades (e.g., blades 342) extending from the tip along the axial length, at least some of the multiple blades comprise an acute-angled cutting edge (e.g., acute-angled cutting edge 344) along at least a portion of the axial length.

The method 800 further includes, in 804, cutting the well cover (e.g., well cover 112) with at least some of the multiple blades (e.g., blades 342) comprising the acute-angled cutting edge (e.g., acute-angled cutting edge 44). In some embodiments, such pipette tips including the cross section shown in FIG. 3E, the method 800 can further comprise, in 806, forming a pressure relief between the multiple blades comprising the acute-angled cutting edge and the well cover.

While the disclosure is susceptible to various modifications and alternative forms, specific assembly and apparatus embodiments and methods thereof have been shown by way of example in the drawings and are described in detail herein. It should be understood, however, that it is not intended to limit the disclosure to the particular assemblies, apparatus, or methods disclosed, but, to the contrary, the intention is to cover all modifications, equivalents, and alternatives falling within the scope of the claims.

What is claimed is:

1. A pipette tip of a pipette assembly configured to aspirate and dispense a liquid, comprising:
a tip body having a first end configured to detachably couple to a pipette, and a tip located opposite from the first end, the tip comprising an opening, wherein the pipette tip further comprises one or more blades having a length extending at least partway from the tip to the first end, at least some of the one or more blades comprising an acute-angled cutting edge along at least a portion of the length.

2. The pipette tip of claim 1, comprising two or more of the blades.

3. The pipette tip of claim 1, comprising three or more of the blades.

4. The pipette tip of claim 1, comprising four of the blades.

5. The pipette tip of claim 1, comprising four blades each comprising the acute-angled cutting edge along the length.

6. The pipette tip of claim 1, wherein the one or more blades further comprise, in plan view, a first tapered profile and a second tapered profile wherein the second tapered profile is less steep than the first tapered profile.

7. The pipette tip of claim 6, wherein the first tapered profile is angled at a first taper angle from 22.5 degrees to 60 degrees measured relative to an axial axis of the pipette tip.

8. The pipette tip of claim 7, wherein the first taper angle is from 30 degrees to 50 degrees.

9. The pipette tip of claim 6, wherein the second tapered profile is angled at a second taper angle of from 0.5 degrees to 4 degrees relative to an axial axis of the pipette tip.

10. The pipette tip of claim 1, wherein the acute-angled cutting edge comprises a cutting angle Δ of from 22.5 degrees to 45 degrees.

11. The pipette tip of claim 10, wherein the cutting angle Δ is from 30 degrees to 40 degrees.

12. The pipette tip of claim 1, wherein the acute-angled cutting edge is formed by a first planar surface intersecting with a second planar surface to form a cutting angle Δ on at least some of the one or more blades.

13. The pipette tip of claim 1, wherein the pipette body comprises a first body portion comprising first conical taper segments and a second body portion comprising second conical taper segments, the one or more blades extending outwardly between respective ones of the first conical taper segments and the second conical taper segments.

14. The pipette tip of claim 13, wherein the second conical taper segments comprise a steeper cone angle than the first conical taper segments.

15. The pipette tip of claim 1, comprising multiple blades extending at least partway from the tip wherein each of the blades includes an acute-angled cutting edge.

16. The pipette tip of claim 1, wherein the tip comprises a planar annulus surrounding the opening, the planar annulus comprising an annular thickness greater than 0.5 mm and less than 1.0 mm.

17. The pipette tip of claim 16, wherein the planar annulus surrounding the opening lies in a plane perpendicular to an axial axis of the pipette tip.

18. The pipette tip of claim 16, wherein the tip comprises a conical portion surrounding the planar annulus.

19. The pipette tip of claim 18, wherein the conical portion includes an included cone angle of from 45 degrees and 120 degrees.

20. A pipette assembly configured to aspirate and dispense a liquid, comprising:
a moveable body,
a pipette coupled to the moveable body, the pipette further comprising a pipette tip portion comprising a tip having an opening, wherein the pipette tip portion further comprises multiple blades each having a length extending at least partway from the tip, the multiple blades each comprising an acute-angled cutting edge along at least a portion of their length.

21. The pipette assembly of claim 20, wherein the pipette tip portion comprises a tip body with a first end that is detachably coupled to the pipette, wherein the tip is located opposite from the first end.

22. An aspiration and dispense system, comprising:
an aspiration and dispense assembly comprising a pump;
a pipette assembly configured to aspirate and dispense a liquid, the pipette assembly comprising a pipette tip portion further comprising:
a tip comprising an opening and further comprising one or more blades having a length extending at least partway from the tip, the one or more blades comprising an acute-angled cutting edge along the length; and
a passageway connected between the pipette assembly and the pump.

23. A pipette configured to aspirate and dispense a liquid, comprising:
a pipette body having a tip comprising an opening and an axial length, wherein the pipette body further comprises one or more blades extending from the tip along the axial length, the one or more blades comprising an acute-angled cutting edge along at least a portion of the axial length.

24. A method of accessing a well that is covered by a well cover with a pipette, comprising:
providing a pipette body portion having an axial length and a tip comprising an opening, wherein the pipette body portion further comprises multiple blades extending from the tip along the axial length, at least some of the multiple blades comprising an acute-angled cutting edge along at least a portion of the axial length; and
cutting the well cover with at least some of the multiple blades comprising the acute-angled cutting edge.
